(19) United States
(12) Patent Application Publication
(10) Pub. No.: US 2017/0173876 A1
(43) Pub. Date: Jun. 22, 2017

(54) 3D printing device for producing a spatially extended product

(71) Applicant: LILAS GmbH, Dortmund (DE)

(72) Inventor: Vitalij LISSOTSCHENKO, Froendenberg (DE)

(21) Appl. No.: 15/381,001

(22) Filed: Dec. 15, 2016

(30) Foreign Application Priority Data
Dec. 17, 2015 (DE) 10 2015 122 130.6
Apr. 15, 2016 (DE) 10 2016 107 052.1

(51) Int. Cl. B29C 67/00; G02B 26/10; G02B 13/00; B33Y 30/00

(52) U.S. Cl. CPC B29C 67/0077; B29C 67/0085; B33Y 30/00; G02B 26/105; G02B 13/0005; B29K 2105/251

(57) ABSTRACT

3D printing device for producing a spatially extended product, with at least one laser light source from which a laser radiation (1, 1′, 1″) can emerge, a working area (4) to which a starting material to be exposed to laser radiation (1, 1′, 1″) is supplied, wherein the working area (4) is arranged in the 3D printing device such that the laser radiation (1, 1′, 1″) is incident on the working area (4), and scanning arrangements designed in particular as movable mirrors (2, 12, 13), wherein the scanning arrangements are able to supply the laser radiation (1, 1′, 1″) specifically to desired locations in the working area (4), wherein the at least one laser light source is designed in such a way that during operation of the device, a plurality of mutually spaced-apart points of incidence or areas of incidence of the laser radiation are generated on the working area (4).

This is an application claiming priority to 10 2015 122 130.6 filed on Dec. 17, 2015 and DE 10 2016 107 052.1 filed on Apr. 15, 2016, which applications are incorporated by reference in their entirety.

### BACKGROUND OF THE INVENTION

The present invention relates to a 3D printing device for producing a spatially extended product according to the preamble of claim 1.

In conventional 3D printing devices, for example, a quantity of energy is applied point-shaped with a laser beam to a starting material which is fed in powder form, so as to initiate at the location where the energy is applied a process, for example melting or sintering of the starting material, wherein this process causes the grains of the starting material to fuse. The product to be manufactured is thus produced layer-by-layer by scanning the laser radiation across the working area in a grid pattern.

A device of the aforementioned type is disclosed, for example, in Sabina Luisa Campanelli, Nicola Contuzzi, Andrea Angelastro and Antonio Domenico Ludovico (2010), Capabilities and Performances of the Selective Laser Melting Process, New Trends in Technologies: Devices, Computer, Communication and Industrial Systems Meng Joo Er (Ed.), ISBN: 978-953-307-212-8, InTech (see also: http://www.intechopen.com/books/new-trends-in-technologies--devices—Computer-communication-and-industrial-systems/capabilities-and-performances-of-the-selective-laser-melting-process). A part of a conventional device is shown schematically in FIG. 1.

Therein, a collimated laser beam 1 is incident from the left on two movable mirrors 2, of which only one is shown. The two mirrors 2 deflect the laser radiation 1 in two mutually perpendicular directions in order to enable scanning in the working plane 4 in two mutually independent directions. The mirrors may be designed, for example, as Galvano mirrors. From the mirrors, the laser radiation is directed by optical means 3 designed as an F-theta objective to a working plane 4, so that the focal plane of the laser radiation 1 lies essentially in the working plane 4. The mirrors 2 may hereby direct the laser radiation specifically to those points in the working plane 4 where a starting material, for example in form of a powder, is to be exposed to the laser radiation. The mirrors 2 and the optical means 3 are usually combined in standard laser heads.

This 3D printing device may disadvantageously require a very long time to produce larger products due to the point-by-point scanning of the working plane.

### BRIEF SUMMARY OF THE INVENTION

The task underlying the present invention is the creation of a 3D printing device which is more effective, in particular faster than the prior art devices.

According to the invention, this is achieved with a 3D printing device of the type mentioned at the beginning having the characterizing features of claim 1. The dependent claims relate to preferred embodiments of the invention.

According to claim 1, the at least one laser light source is designed in such a way that during the operation of the device several spaced-apart points of incidence or spaced-apart regions of incidence of the laser radiation are generated on the working area.

During the operation of the 3D printing device, the powdered starting material may be solidified simultaneously at several locations by the plurality of mutually spaced-apart points of incidence or regions of incidence of the laser radiation in the working area. This shortens the time required to produce the product.

The scanning means may include at least one movable and at least one non-movable mirror, wherein in particular the at least one movable mirror is larger than the at least one non-movable mirror.

The 3D printing device may include at least two laser light sources with laser radiation emerging from each of the laser light sources; in particular, the exit faces of the at least two laser light sources may be spaced apart in a plane perpendicular to the mean propagation direction of the laser radiations. The laser radiations of the at least two laser light sources may thus be introduced simultaneously into the working plane thereby reducing the processing time commensurately.

The scanning means may include a plurality of non-movable mirrors, wherein each of the laser radiations is assigned to at least one of the non-movable mirrors.

The scanning means may include one or more movable mirrors which deflect several of the laser radiations, in particular all of the laser radiations, during operation of the 3D printing device. In this way, for example, one or two large movable mirrors may be provided which deflect several of the laser radiations, in particular all of the laser radiations. The large mirrors may be relatively insensitive to large laser powers. Furthermore, other movement systems may be used instead of Galvano actuators for moving the large mirrors, so that the system as a whole can become more robust and more cost-effective.

The scanning means may be designed in such a way that the points of incidence or the areas of incidence of the laser radiation can be moved on the working area in the direction in which the points of incidence or areas of incidence of the laser radiation are arranged next to one another. With this movement, an area of the working area to be exposed to laser radiation is exposed to laser radiation several times in short succession. As a result, the exposure time of the individual focus point can be reduced, since sufficient energy can nevertheless be introduced into the area by the successive application, for example, to melt the starting material. In this way, the speed at which the focus points are moved across the working plane can be increased. Overall, the processing time can also be reduced in this manner.

### BRIEF DESCRIPTION OF THE DRAWINGS

Other features and advantages of the present invention will become apparent from the following description of preferred embodiments with reference to the accompanying drawings, which show in:

FIG. 1 a schematic diagram of a 3D printing device according to the prior art;

FIG. 2 a schematic diagram of a first embodiment of a 3D printing device according to the invention;

FIG. 3 a schematic diagram of a plurality of laser light sources for a 3D printing device according to the invention;

FIG. 4 a schematic view for illustrating the function of the 3D printing device according to the invention shown in FIG. 2;

FIG. 5 a schematic diagram of a second embodiment of a 3D printing device according to the invention;

FIG. 6 a schematic diagram of a third embodiment of a 3D printing device according to the invention;

FIG. 7a a schematic diagram of a first arrangement of exit faces of the plurality of laser light sources for a 3D printing device according to the invention;

FIG. 7b a schematic diagram of a second arrangement of exit faces of the plurality of laser light sources for a 3D printing device according to the invention;

FIG. 7c a schematic diagram of a third arrangement of exit faces of the plurality of laser light sources for a 3D printing device according to the invention;

FIG. 7d a schematic diagram of a fourth arrangement of exit faces of the plurality of laser light sources for a 3D printing device according to the invention;

FIG. 8 a schematic diagram of a first arrangement of focus points in the working plane for a 3D printing device according to the invention;

FIG. 9 a schematic diagram of a second arrangement of focus points in the working plane for a 3D printing device according to the invention;

FIG. 10 a schematic diagram of a fourth embodiment of a 3D printing device according to the invention;

FIG. 11 a diagram corresponding to FIG. 5 of the second embodiment with illustrated movement of the focus points in the working plane; and

FIG. 12 a diagram corresponding to FIG. 10 of the fourth embodiment with illustrated movement of the focus points in the working plane.

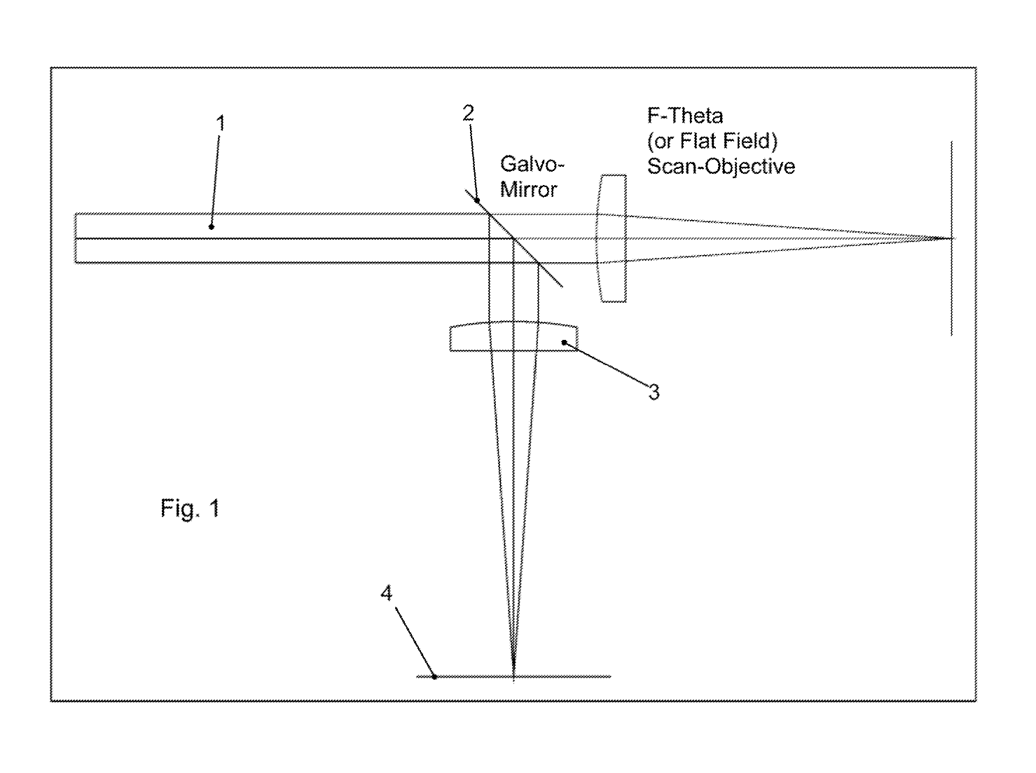

### DETAILED DESCRIPTION OF THE INVENTION

In the figures, identical and functionally identical parts are provided with the same reference symbols.

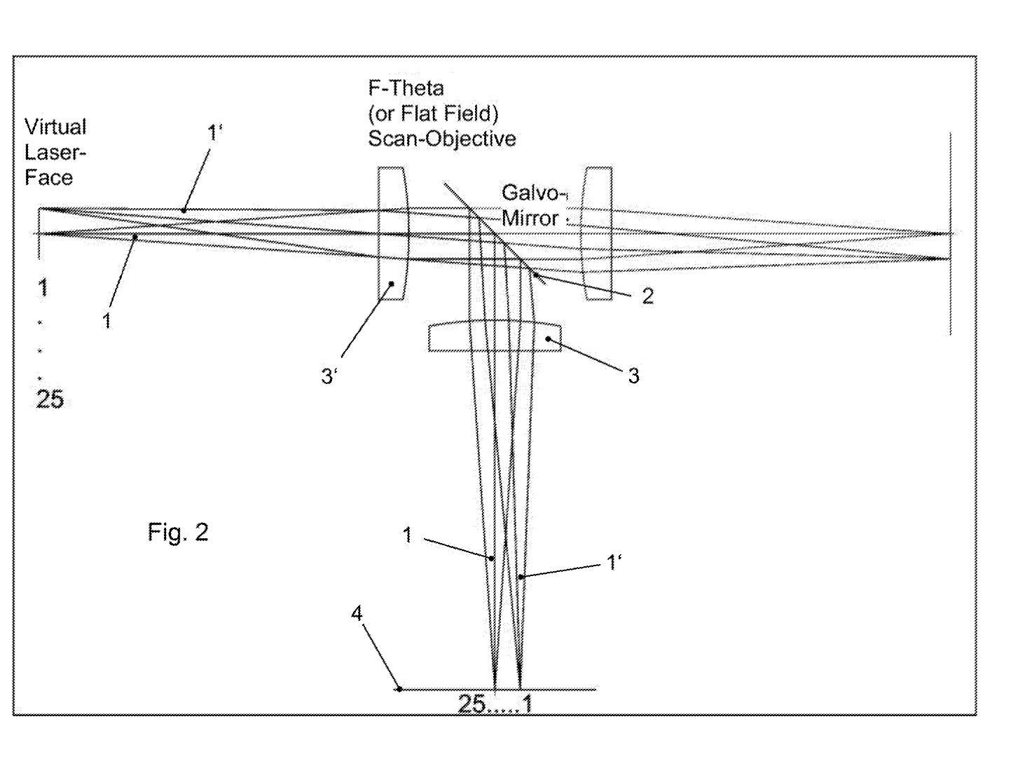

In the embodiment of a 3D printing device shown in FIG. 2, a second laser light source is provided in addition to the first laser light source, thus generating an additional laser radiation 1′. The exit face of the second laser light source is spaced apart from the exit face of the first laser light source in a plane perpendicular to the mean propagation direction of the laser radiations 1, 1′, in particular between 10 μm and 10 mm, for example, approximately 100 μm. The laser radiations 1, 1′ are also incident at a distance from one another in the working plane 4 (see, for example, FIG. 2).

The propagation directions of the laser radiations 1, 1′ are slightly tilted relative to each other so that they are incident approximately together on the mirrors 2 or shortly in front or shortly behind the mirrors 2. Both laser radiations 1, 1′ are deflected by the mirrors 2 simultaneously and together.

Additional optical means 3′, which may in particular also be designed as an F-theta objective and which may for example exactly correspond to the optical means 3, may be disposed in the 3D printing device in front of the mirrors 2. However, differently designed optical means 3′ which have, for example, a different focal length than the optical means 3 may also be provided.

The optical means 3′ may also be omitted completely and both the laser radiation 1 and the laser radiation 1′ may be allowed to strike the mirrors 2 as largely collimated laser radiation. Here again, the propagation directions of the laser radiations 1, 1′ should be tilted slightly relative to each other so as to be incident on the mirrors 2 approximately together or shortly in front or behind the mirrors 2.

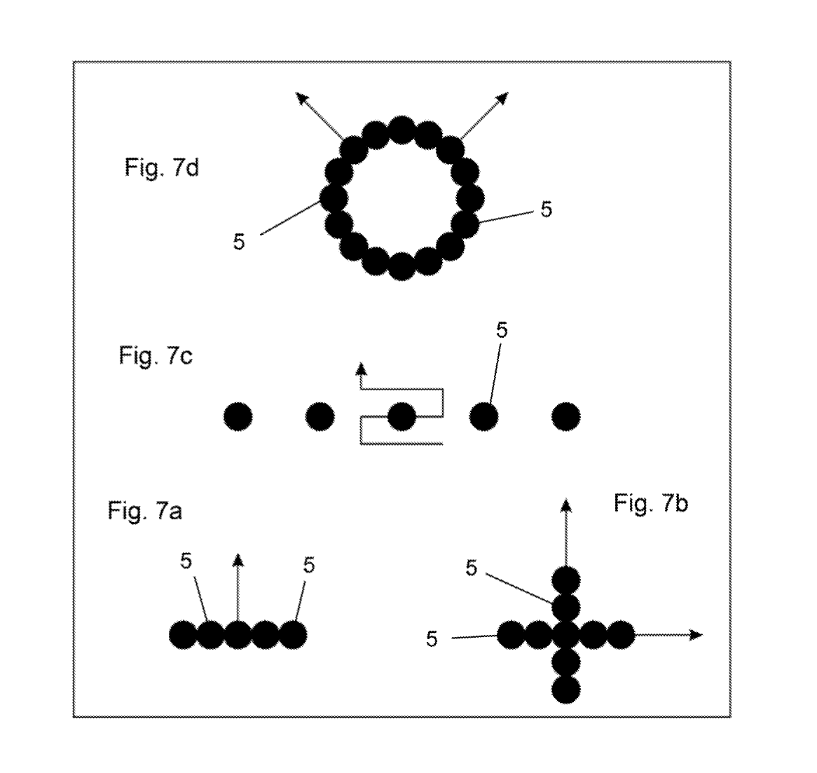

Instead of only two laser light sources, more than two, for example as indicated in FIG. 2, 25 laser light sources or more than 25 laser light sources may be used. FIGS. 7a to 7d show the exemplary arrangement of the exit faces 5 of a plurality of laser light sources. These are arranged, for example, in a row (FIG. 7a) or the shape of a cross (FIG. 7b). A circular shape (FIG. 7d) or row shape with larger spacings (FIG. 7c) are also shown. Other arrangements are also possible.

By arranging, for example, a plurality of focus points side-by-side in the working plane 4, the powdered starting material can be solidified simultaneously at several locations, thereby shortening the time required to produce the product. This also applies correspondingly to other arrangements of the exit faces of the laser light sources.

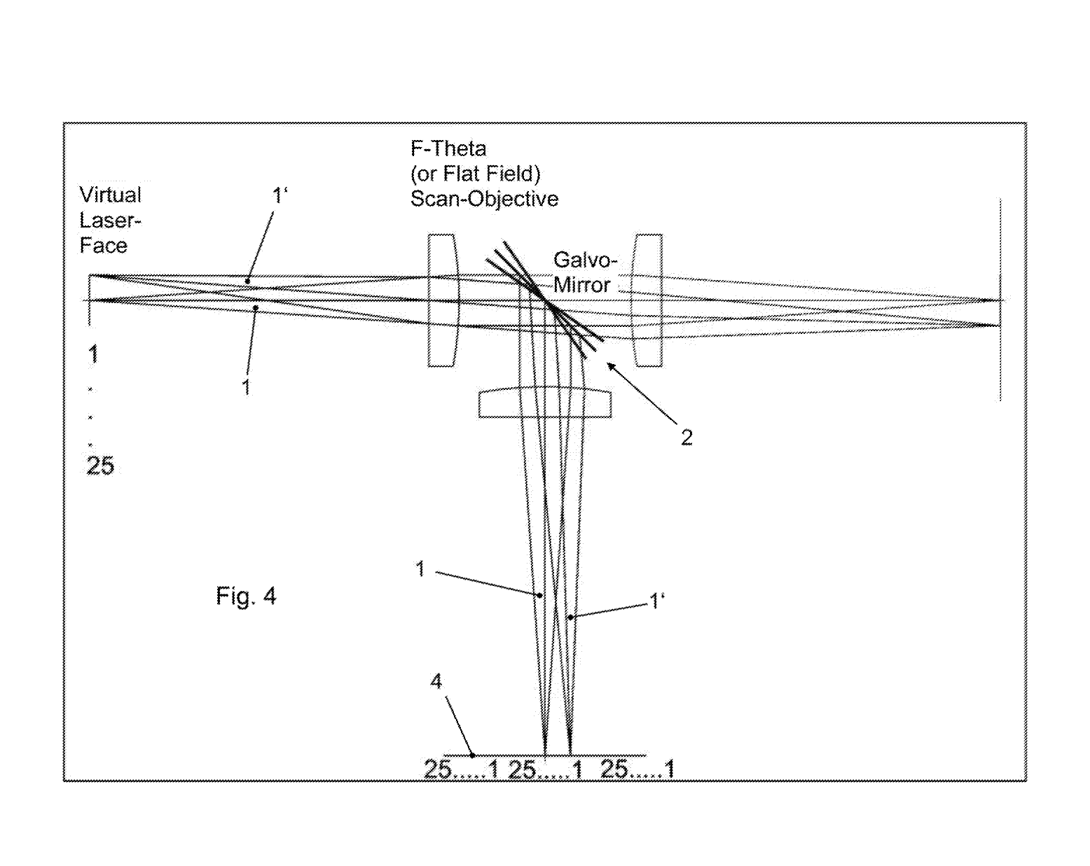

FIG. 4 illustrates that the focus points of the different laser radiations 1, 1′ are moved simultaneously in the working plane 4. Various mirror positions are indicated.

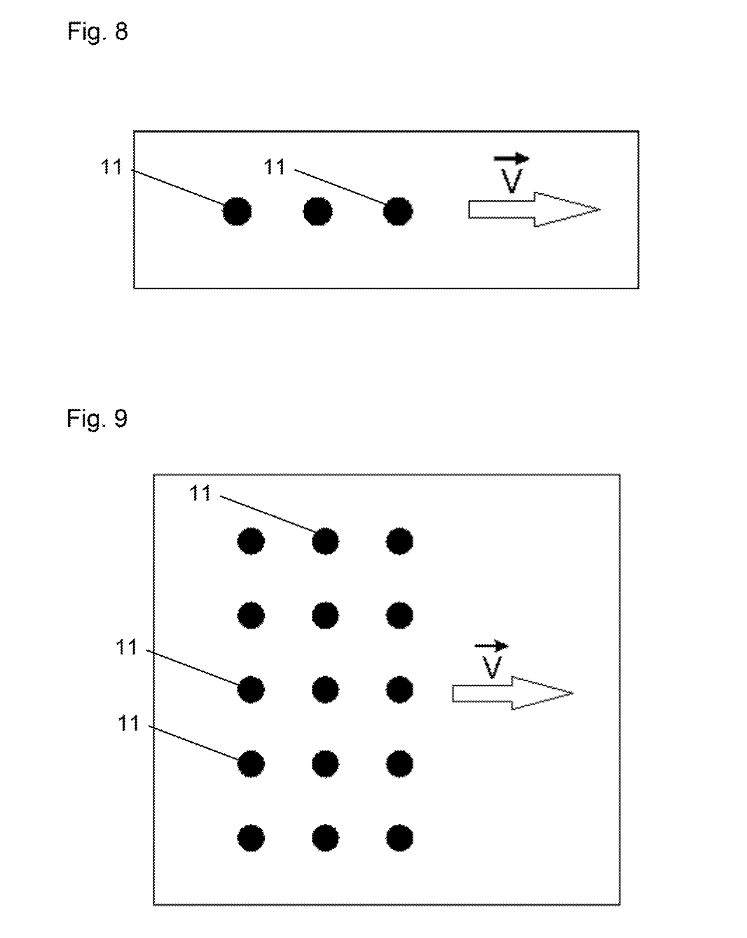

FIG. 8 shows a line-shaped arrangement of focus points 11 in the working plane. This arrangement is moved in the longitudinal direction of the line as indicated by the arrow v. Laser radiation is applied to an area of the working plane to be exposed to laser radiation several times in succession by the movement in the longitudinal direction of the line. As a result, the exposure duration of the individual focus point 11 can be reduced, since sufficient energy, for example, to melt the starting material can nevertheless be introduced into the region by the successive exposure.

In this way, the speed at which the focus points 11 are moved across the working plane can be increased. Overall, the processing time can thereby also be reduced.

FIG. 9 shows an exemplary embodiment with an arrangement of several parallel lines of focus points 11 in the working plane. These are also moved in the longitudinal direction of the parallel lines as indicated by the arrow v.

With the movement in the longitudinal direction of the parallel lines, laser radiation is applied simultaneously and several times in short succession to several areas of the working plane to be exposed to laser radiation. As a result, the exposure duration of the individual focus points 11 can be reduced, since sufficient energy, for example, to melt the starting material can nevertheless be introduced into the areas by the successive application.

In contrast to FIG. 8, this melting occurs in the embodiment in FIG. 9 in several areas in parallel. Overall, the processing time can thus be further reduced.

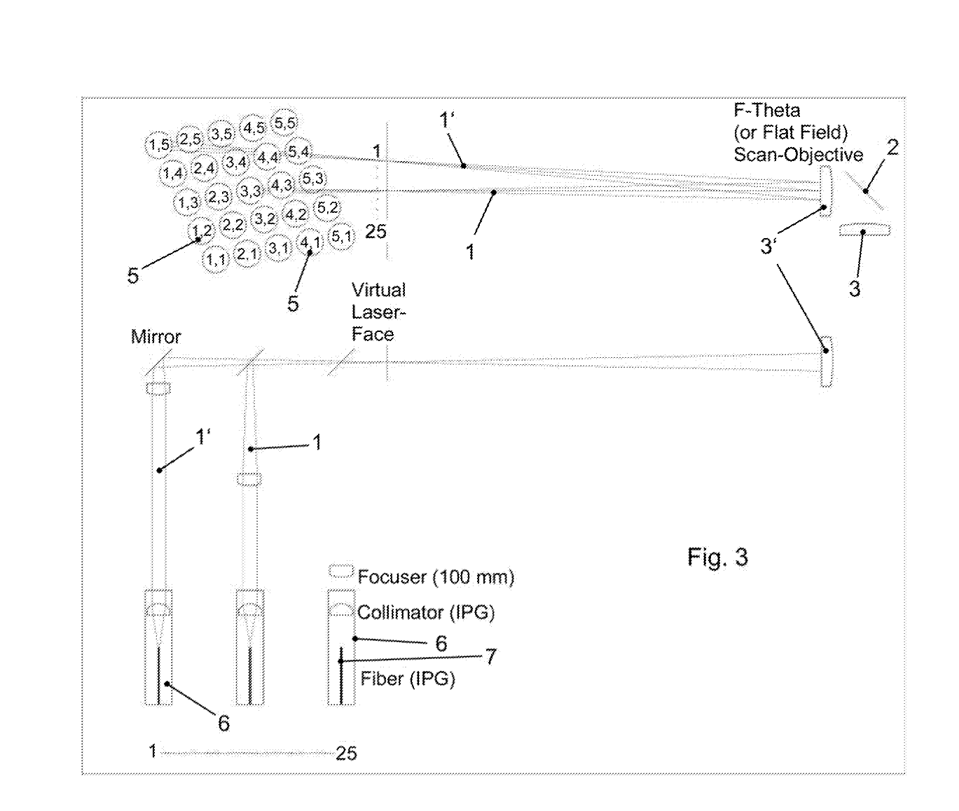

FIG. 3 illustrates how, for example, a diamond-shaped arrangement of several, in particular 25, exit faces for laser radiation 1, 1′ can be created with a plurality of schematically indicated laser light sources 6, in particular with 25 laser light sources 6.

In the exemplary embodiment shown, the laser light sources are shown as exit ends of optical fibers 7. However, other laser light sources may also be used.

The ends of the optical fibers 7 are arranged in the form of a bundle with a diamond-shaped cross-section, wherein the laser radiations 1, 1′ . . . emerging therefrom are incident on the additional optical means 3′ after deflection on suitable mirrors 8.

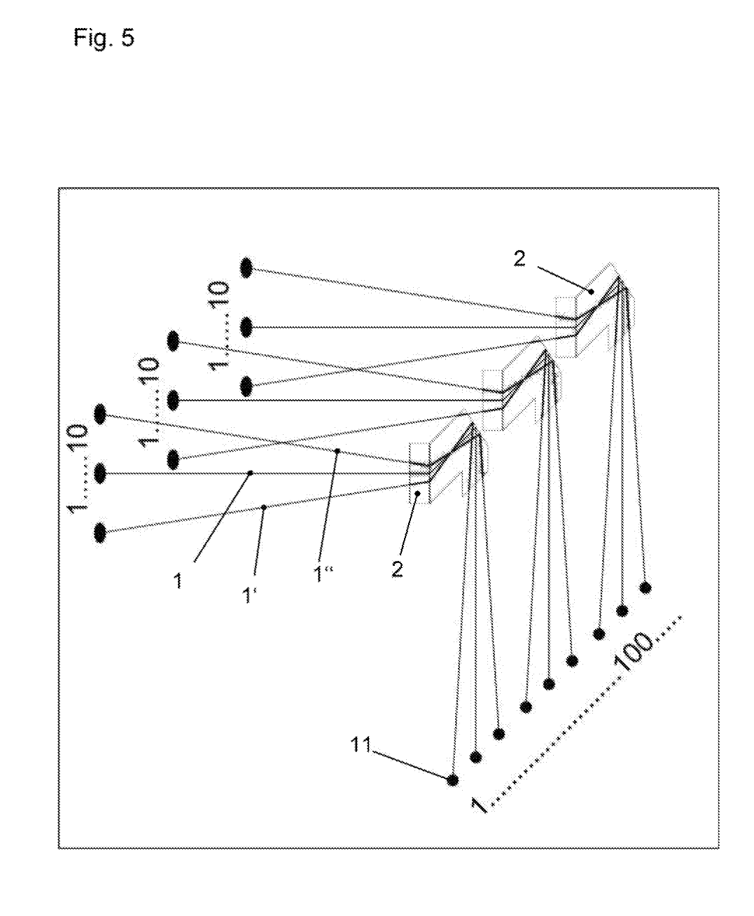

FIG. 5 illustrates how a row of, for example, more than 100 focus points 11 can be obtained in the working plane by suitably selecting several laser light sources and several laser heads with several mirrors 2 and a plurality of (unillustrated) optical means. For this purpose, a plurality of laser heads with mirrors 2 are arranged side-by-side and a plurality, for example 10 laser radiations 1, 1′, 1″ . . . are applied to each of the laser heads. The mirrors 2 can be pivoted perpendicular to one another or about two mutually perpendicular axes.

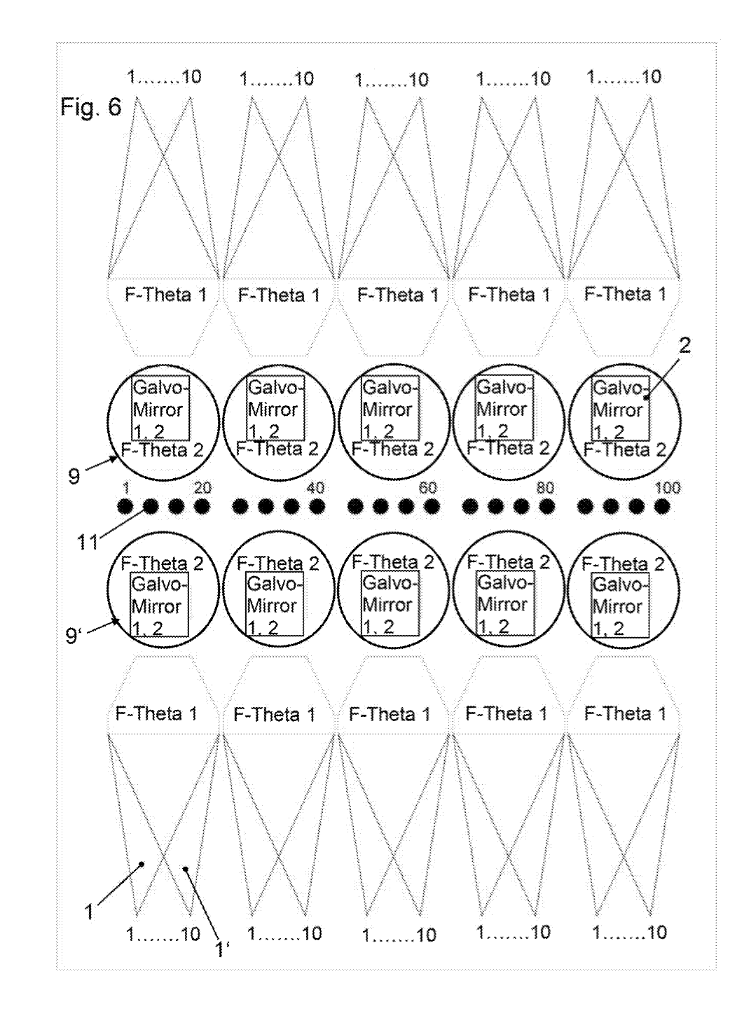

FIG. 6 shows a similar arrangement wherein laser radiations 1, 1′, . . . are incident from two different sides on the mirrors 2 which are arranged here in two mutually parallel rows 9, 9′. This arrangement also produces in the working plane a long row of, for example, 100 or more focus points 11.

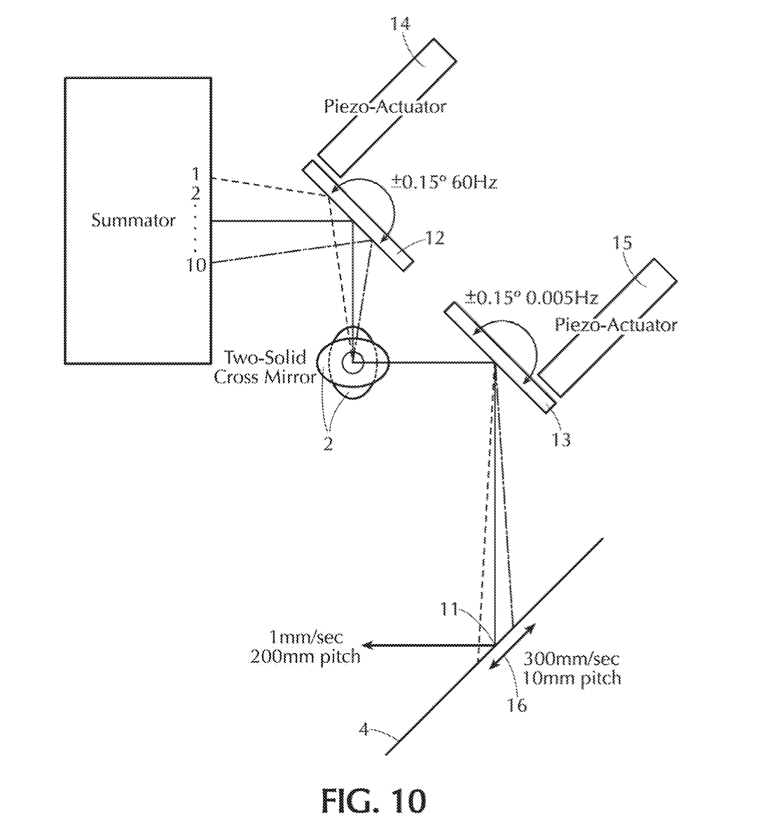

FIG. 10 shows an arrangement wherein, in contrast to FIG. 5, the mutually perpendicular mirrors 2 are not movable, but are instead non-movable. Similarly to FIG. 5, two of these mirrors 2 are provided for each channel or for each laser light source.

For moving the focus points 11 in the working plane in spite of the immovability of the mirrors 2, at least one movable mirror 12, 13 is disposed in front of and behind each the mirrors 2. These mirrors 12, 13 are elongated and are capable of simultaneously deflecting several of the laser radiations 1, 1′, 1″ or all of the laser radiations. In particular, the mirrors 12, 13 can be pivoted using piezo-actuators 14, 15.

The movement of the first mirror 12 causes the focus points 11 to move in the longitudinal direction 16, in which the plurality of focus points 11 are arranged side-by-side. The movement of the second mirror 13 causes the focus points 11 to move in a direction perpendicular to the longitudinal direction 16.

It has been observed that in order to carry out the desired movements of the focus points 11 in the working plane 4, the first mirror 12 may be moved, for example, only in a range of ±0.15° at a frequency of 60 Hz, whereas the second mirror 13 may be moved in a range of ±15° at a frequency of 0.005 Hz. Owing to these slow movements or small-amplitude movements, other embodiments of drives, such as for example piezo-actuators 14, 15, may be used instead of the Galvano mirrors.

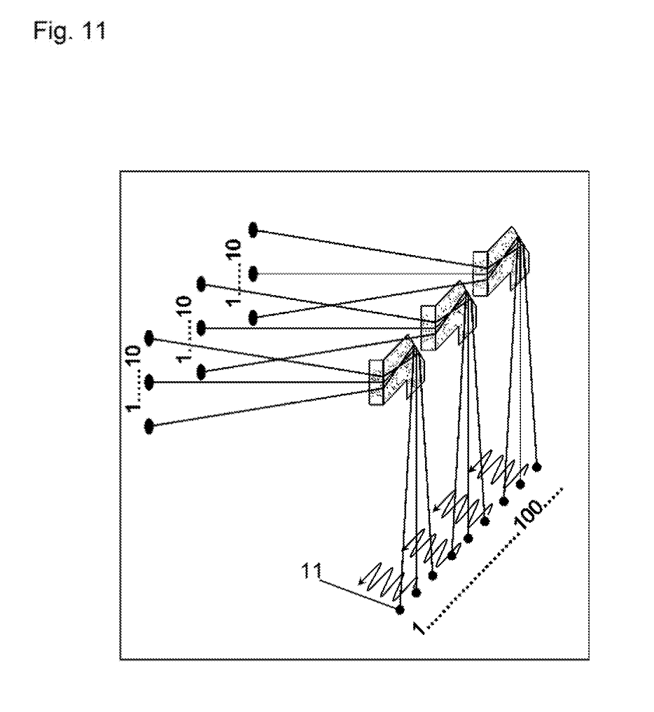

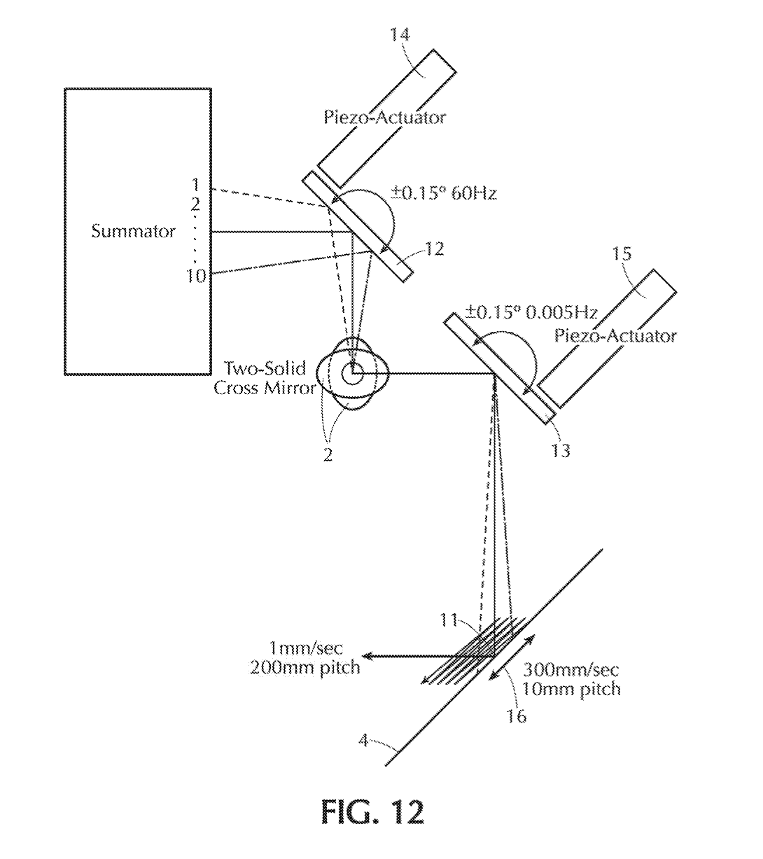

With the movements in a first direction and a second direction perpendicular thereto, a zigzag movement of a beam can be generated. FIG. 11 schematically illustrates in a diagram similar to FIG. 5 the zigzag-shaped movement of the individual focus points 11. FIG. 12 schematically illustrates in a diagram similar to FIG. 10 the zigzag-shaped movement of the individual focus points 11.

Every issued patent, pending patent application, publication, journal article, book or any other reference cited herein is each incorporated by reference in their entirety.

1. A 3D printing device for producing a spatially extended product, comprising
at least one laser light source from which laser radiation (1, 1′, 1″) emerges,
a working area (4) to which starting material to be exposed to laser radiation (1, 1′, 1″) for the 3D printing is supplied, wherein the working area (4) is arranged in the 3D printing device such that the laser radiation (1, 1′, 1″) is incident on the working area (4), and
scanning arrangement designed to supply the laser radiation (1, 1′, 1″) specifically to desired locations in the working area (4),
wherein at least one laser light source is designed such that during the operation of the device a plurality of mutually spaced-apart points of incidence or areas of incidence of the laser radiation are generated on the working area (4).

2. The 3D printing device according to claim 1, wherein, during the operation of the 3D printing device, the powdered starting material is solidified simultaneously at several points by the plurality of mutually spaced-apart points of incidence or areas of incidence of the laser radiation in the working area (4).

3. The 3D printing device according to claim 1, wherein the scanning arrangements comprise at least one movable mirror (12, 13) and at least one non-movable mirror (2), wherein the at least one movable mirror (12, 13) is larger than the at least one non-movable mirror (2).

4. The 3D printing device according to claim 1, wherein the 3D printing device comprises at least two laser light sources, with a corresponding laser radiation (1, 1′, 1″) emitted from each of the at least two laser light sources.

5. The 3D printing device according to claim 1, wherein the scanning arrangements comprise a plurality of non-movable mirrors (2), wherein each of the laser radiations (1, 1′, 1″) is associated with at least one of the non-movable mirrors (2).

6. The 3D printing device according to claim 1, wherein the scanning arrangements comprise one or more movable mirrors (12, 13), wherein during operation of the 3D printing device several of the laser radiations (1, 1′, 1″) are deflected.

7. The 3D printing device according to claim 1, wherein the scanning arrangements are designed in such a way that the points of incidence or areas of incidence of the laser radiation on the working area (4) are moved in the direction in which the points of incidence or areas of incidence of the laser radiations are arranged side-by-side.

8. The 3D printing device according to claim 1, wherein the 3D printing device comprises optical arrangements (3), which are in particular designed as an F-theta objective or as a flat-field scanning objective, wherein the optical arrangements are able to focus the laser radiation into the working area.

9. The 3D printing device according to claim 1, wherein additional optical arrangement (3′) are provided between the at least two laser light sources and the scanning arrangements.

10. The 3D printing device according to claim 9, wherein the additional optical arrangements (3′) resemble or correspond to the optical arrangements (3) arranged between the scanning arrangements and the working area.

11. The 3D printing device according to claim 1, wherein no additional optical arrangements are provided between the at least two laser light sources and the scanning arrangement.

12. The 3D printing device according to claim 1, wherein the laser radiation (1, 1′, 1″) emerges from the at least two laser light sources substantially collimated.

13. The 3D printing device according to claim 1, wherein a mean propagations direction of the laser radiations (1, 1′, 1″) emerging from different ones of the at least two laser light sources enclose an angle with one another.

14. The 3D printing device according to claim 1, wherein the laser light sources are designed as ends of optical fibers (7).

15. The 3D printing device according to claim 1, wherein the laser light sources are designed as laser devices.

16. The 3D printing device according to claim 1, wherein the scanning arrangements are designed as movable mirrors (2, 12, 13).

17. The 3D printing device according to claim 4, wherein the corresponding laser radiation (1, 1′, 1″) emitted from each of the at least two laser light sources and wherein the exit faces (5) of the at least two laser light sources are spaced apart from one another in a plane perpendicular to the mean propagation direction of the laser radiation (1, 1′, 1″).

18. The 3D printing device according to claim 6, wherein all of the laser radiations (1, 1′, 1″) are deflected.

19. The 3D printing device according to claim 8, wherein the 3D printing device comprises optical arrangements (3), which are designed as an F-theta objective or as a flat-field scanning objective.

20. The 3D printing device according to claim 19, wherein the 3D printing device comprises optical arrangements (3) arranged between the scanning arrangement and the working area, wherein the optical arrangements are able to focus the laser radiation into the working area.

21. The 3D printing device according to claim 10, wherein the additional optical arrangements (3′) are also designed as an F-theta objective or as a flat-field scanning objective.

22. The 3D printing device according to claim 13, wherein the angle with one another is a small angle of for example less than 10°.
